(19) United States
(12) Patent Application Publication
(10) Pub. No.: US 2010/0007682 A1
(43) Pub. Date: Jan. 14, 2010

(54) LIQUID CRYSTAL DISPLAY AND METHOD OF DRIVING THE SAME

(75) Inventors: Yong-Hoon KWON, Asan-si (KR); Gi-Cherl KIM, Yongin-si (KR); Dong-Min YEO, Asan-si (KR); Sang-Il PARK, Seoul (KR); Hee-Kwang SONG, Anyang-si (KR); Ho-Sik SHIN, Anyang-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/485,455

(22) Filed: Jun. 16, 2009

(30) Foreign Application Priority Data
Jul. 11, 2008 (KR) 10-2008-0067716

(51) Int. Cl. G09G 3/36; G09G 5/10

(52) U.S. Cl. 345/690; 345/99

(57) ABSTRACT

A liquid crystal display (“LCD”) includes; a liquid crystal panel including a plurality of display blocks, a light-emitting unit which provides light to the liquid crystal panel and includes a plurality of light-emitting blocks corresponding to the display blocks, respectively; and a timing controller which provides an optical data signal for controlling the light-emitting blocks, wherein the optical data signal includes a plurality of scan signals and a plurality of dimming signals which are alternatingly arranged, and each of the dimming signals controls a luminance of a corresponding one of the light-emitting blocks.

This application claims priority to Korean Patent Application No. 10-2008-0067716, filed on Jul. 11, 2009, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) and a method of driving the same.

2. Description of the Related Art

A liquid crystal display (“LCD”) includes a first display substrate having a plurality of pixel electrodes, a second display substrate having a plurality of common electrodes, and a liquid crystal layer having dielectrically anisotropic liquid crystal molecules injected between the first and second display substrates. The LCD displays a desired image by forming an electric field between the pixel electrodes and the common electrodes, adjusting the intensity of the electric field, controlling an orientation of the liquid crystal molecules with respect to at least one polarizer, and thus controlling the amount of light that transmits through the liquid crystal panel. Since the LCD is not a self light-emitting display, it may include a light source, such as a plurality of light-emitting blocks.

A technology, which controls the luminance of each light-emitting block according to an image displayed on the liquid crystal panel in order to enhance image quality, would be desirable.

### BRIEF SUMMARY OF THE INVENTION

Exemplary embodiments of the present invention provide a liquid crystal display (“LCD”) with enhanced display quality.

Exemplary embodiments of the present invention also provide a method of driving an LCD with enhanced display quality.

However, the present invention is not restricted to the one set forth herein. The above and other aspects of the present invention will become more apparent to one of ordinary skill in the art to which the present invention pertains by referencing the detailed description of the present invention given below.

According to an aspect of the present invention, an exemplary embodiment of an LCD includes; a liquid crystal panel including a plurality of display blocks, a light-emitting unit which provides light to the liquid crystal panel and includes a plurality of light-emitting blocks corresponding to the display blocks, respectively, and a timing controller which provides an optical data signal for controlling the light-emitting blocks, wherein the optical data signal includes a plurality of scan signals and a plurality of dimming signals which are alternatingly arranged, and each of the dimming signals controls a luminance of a corresponding one of the light-emitting blocks.

According to another exemplary embodiment of the present invention, an LCD includes; a liquid crystal panel including a plurality of display blocks; and a light-emitting unit which provides light to the liquid crystal panel and includes a plurality of light-emitting blocks corresponding to the display blocks, respectively, and a timing controller which provides an optical data signal for controlling the light-emitting blocks, wherein the timing controller includes; a decoder which sequentially generates a plurality of select signals, a first selector which receives a plurality of scan signals and outputs one of the plurality of scan signals according to each of the provided select signals, a second selector which receives a plurality of dimming signals and outputs one of the plurality of dimming signals according to each of the provided select signals, and a serializer which serializes scan signals and dimming signals output from the first selector and the second selector, respectively, and outputs the optical data signal having alternatingly arranged scan signals and dimming signals.

According to another exemplary embodiment of the present invention, a method of driving an LCD includes; dividing a liquid crystal panel into a plurality of display blocks, and providing an optical data signal for controlling a plurality of light-emitting blocks which correspond to the display blocks, respectively, wherein the providing of the optical data signal includes; sequentially generating a plurality of select signals, receiving a plurality of scan signals and outputting one of the scan signals according to each of the select signals, receiving a plurality of dimming signals and outputting one of the dimming signals according to each of the select signals, serializing output scan signals and output dimming signals, and outputting the result of serialization as the optical data signal.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of an exemplary embodiment of a liquid crystal display (“LCD”) according to the present invention;

FIG. 2 is an equivalent circuit diagram of an exemplary embodiment of a pixel included in the exemplary embodiment of an LCD of FIG. 1;

FIG. 3 is a conceptual diagram illustrating the operation of exemplary embodiments of first through p^{th} backlight drivers illustrated in FIG. 1;

FIG. 4 is a block diagram of an exemplary embodiment of a first timing controller illustrated in FIG. 1;

FIG. 5 is a block diagram of an exemplary embodiment of a second timing controller illustrated in FIG. 1;

FIG. 6 is a block diagram of an exemplary embodiment of an optical data signal output unit illustrated in FIG. 5;

FIG. 7 is a conceptual diagram illustrating the operation of the exemplary embodiment of an optical data signal output unit illustrated in FIG. 6;

FIGS. 8A and 8B illustrate a plurality of scan signals and a plurality of dimming signals which correspond to a plurality of select signals, respectively;

FIG. 9 is a conceptual diagram illustrating the operations of exemplary embodiments of first through (n×m)^{th} light-emitting blocks of the exemplary embodiment of an LCD illustrated in FIG. 1;

FIG. 10 is a block diagram of an exemplary embodiment of an optical data signal output unit included in another exemplary embodiment of an LCD according to the present invention; and

FIG. 11 is a conceptual diagram illustrating the operation of the exemplary embodiment of an optical data signal output unit illustrated in FIG. 10.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated components, steps, operations, features, regions, integers, and/or elements, but do not preclude the presence or addition of one or more other components, steps, operations, elements, features, regions, integers and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

As used herein, the terms “rows” and “columns” of a matrix may be changed to “columns” and “rows” depending on an observer's point of view. That is, “rows” may be replaced by “columns” and vice versa.

Hereinafter, exemplary embodiments of a liquid crystal display (“LCD”) and a method of driving the same according to the present invention will be described.

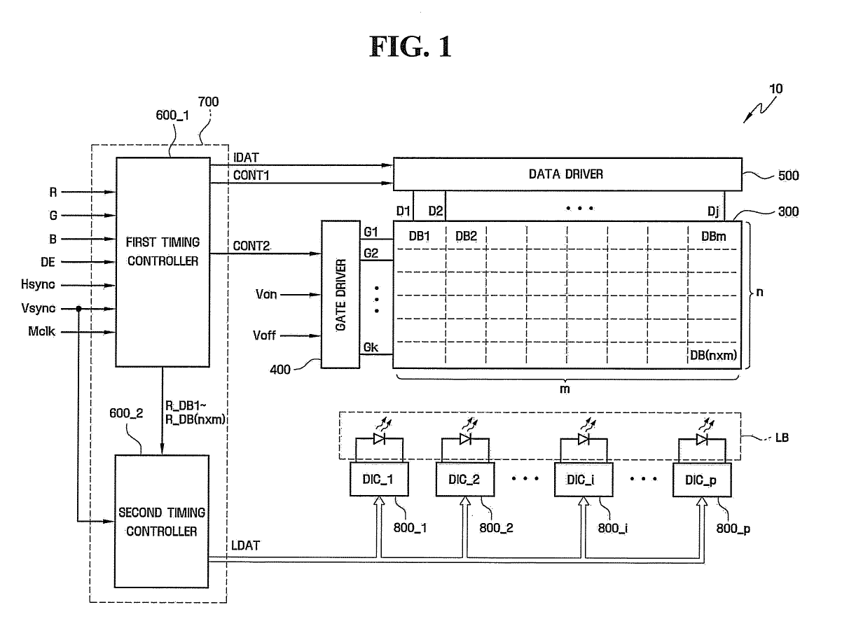

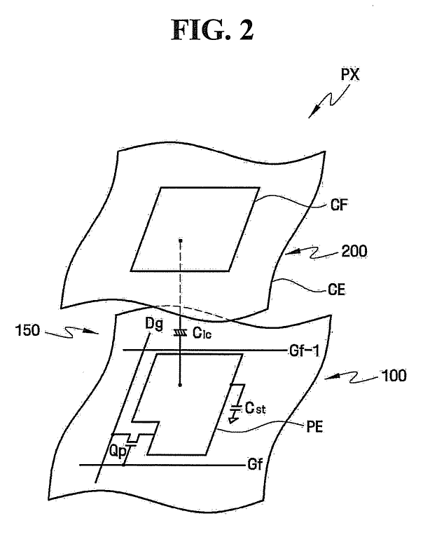

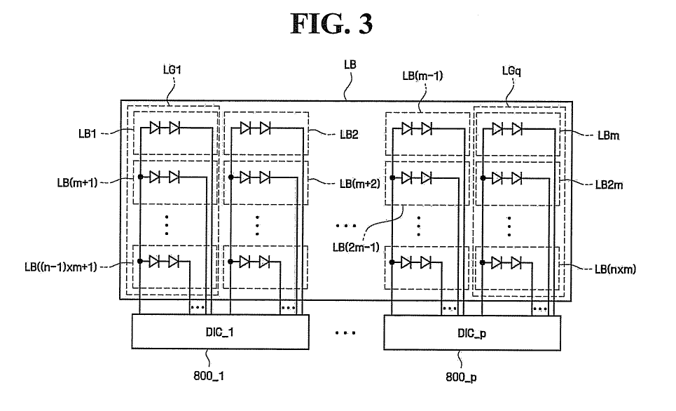

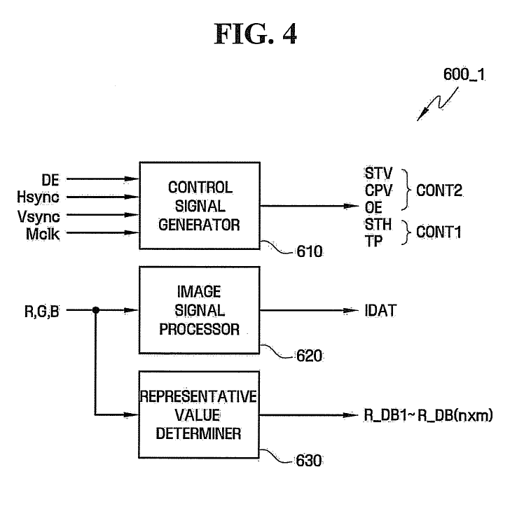

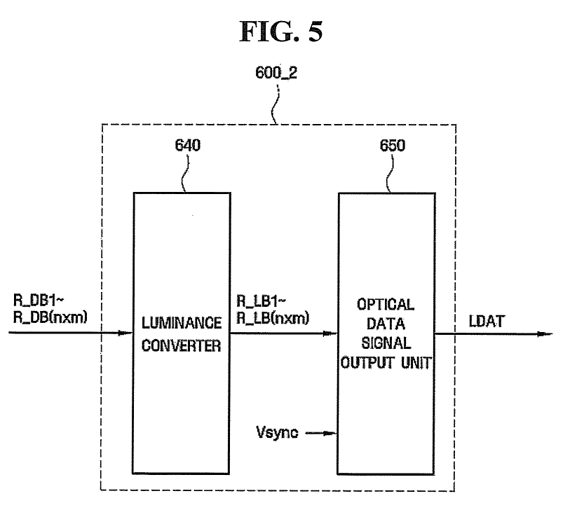

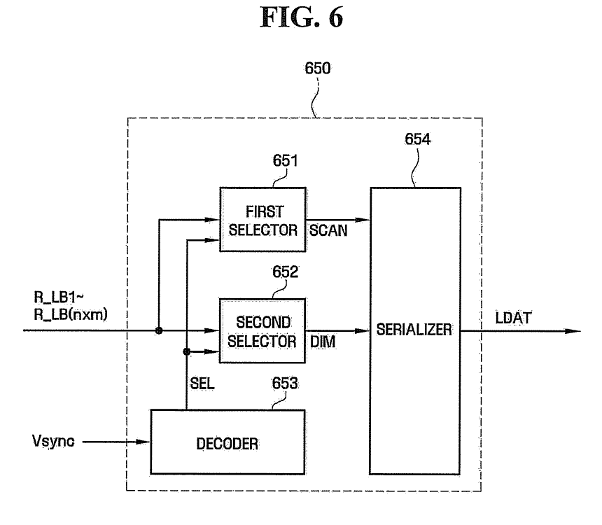

An exemplary embodiment of an LCD according to an exemplary embodiment of the present invention will be described with reference to FIGS. 1 through 6. FIG. 1 is a block diagram of an exemplary embodiment of an LCD 10 according to the present invention. FIG. 2 is an equivalent circuit diagram of an exemplary embodiment of a pixel PX included in the exemplary embodiment of an LCD 10 of FIG. 1. FIG. 3 is a conceptual illustrating the operation of first through p^{th} backlight drivers 800_1 through 800_{—}p illustrated in FIG. 1. FIG. 4 is a block diagram of an exemplary embodiment of a first timing controller 600_1 illustrated in FIG. 1. FIG. 5 is a block diagram of an exemplary embodiment of a second timing controller 600_2 illustrated in FIG. 1. FIG. 6 is a block diagram of an exemplary embodiment of an optical data signal output unit 650 illustrated in FIG. 5.

Referring to FIG. 1, the LCD 10 includes a liquid crystal panel 300, a gate driver 400, a data driver 500, a timing controller 700, the first through p^{th} backlight drivers 800_1 through 800_{—}p, and first through (n×m)^{th} light-emitting blocks LB1 through LB(n×m) (collectively indicated by reference character LB) connected to the first through p^{th} backlight drivers 800_1 through 800_{—}p. In the present exemplary embodiment both n and m are natural numbers.

In the present exemplary embodiment, the timing controller 700 may be functionally divided into the first timing controller 600_1 and the second timing controller 600_2. The first timing controller 600_1 may control images displayed on the liquid crystal panel 300, and the second timing controller 600_2 may control the first through p^{th} backlight drivers 800_1 through 800_{—}p. In addition, exemplary embodiments include configurations wherein the first timing controller 600_1 and the second timing controller 600_2 may be physically separated from each other.

The liquid crystal panel 300 may be divided into a plurality of display blocks DB1 through DB(n×m). The display blocks DB1 through DB(n×m) may be arranged in a matrix of n rows and m columns and correspond to the first through (n×m)^{th} light-emitting blocks LB1 through LB(n×m), respectively. In the present exemplary embodiment, each of the display blocks DB1 through DB(n×m) includes a plurality of pixels. The liquid crystal panel 300 includes a plurality of gate lines G1 through Gk and a plurality of data lines D1 through Dj. In the present exemplary embodiment both j and k are natural numbers.

Referring to FIG. 2, an individual pixel PX is connected to, for example, an f^{th} (wherein f is a natural number from 1 to k) gate line Gf and a g^{th} (wherein g is a natural number from 1 to j) data line Dg and includes a liquid crystal capacitor Clc and a storage capacitor Cst. The liquid crystal capacitor Clc may include a pixel electrode PE formed on a first display substrate 100 and a common electrode CE formed on a second display substrate 200, and a liquid crystal layer 150 interposed between the pixel electrode PE and the common electrode CE. In the present exemplary embodiment, a color filter CF may be formed on a portion of the second display substrate 200, although alternative exemplary embodiments include configurations wherein the color filter CF may be formed on the first substrate 100. In addition, a switching device Qp may be connected to the f^{th} gate line Gf and the g^{th} data line Dg and provide a data voltage to the liquid crystal capacitor Clc. Alternative exemplary embodiments include configurations wherein the storage capacitor Cst may be omitted.

The first timing controller 600_1 receives red, green and blue image signals R, G and B and control signals for controlling the display of the red, green and blue image signals R, G and B from an external graphic controller (not shown). Based on the red, green and blue image signals R, G and B and the control signals, the first timing controller 600_1 generates a data control signal CONT1 and a gate control signal CONT2. Exemplary embodiments of the control signals include a vertical synchronization signal Vsync, a horizontal synchronization signal Hsync, a main clock signal Mclk, and a data enable signal DE.

In addition, the first timing controller 600_1 receives the red, green and blue image signals R, G and B and outputs a plurality of representative image signals R_DB1 through R_DB(n×m) which correspond to the display blocks DB1 through DB(n×m), respectively. That is, the first timing controller 600_1 receives the red, green and blue image signals R, G and B, determines the representative image signals R_DB1 through R_DB(n×m) corresponding to the display blocks DB1 through DB(n×m), respectively, and provides the representative image signals R_DB1 through R_DB(n×m) to the second timing controller 600_2. The operation and internal structure of the first timing controller 600_1 will be described later with reference to FIG. 4.

The second timing controller 600_2 receives the representative image signals R_DB1 through R_DB(n×m) from the first timing controller 600_1 and provides optical data signals LDAT corresponding to the representative image signals R_DB1 through R_DB(n×m) to the first through p^{th} backlight drivers 800_1 through 800_{—}p, respectively. In one exemplary embodiment, the optical data signals LDAT may include optical data signals LDAT1 through LDATp, which are transmitted to the first through p^{th} backlight drivers 800_1 through 800_{—}p, respectively. In addition, each of the optical data signals LDAT, which are provided to the first through p^{th} backlight drivers 800_1 through 800_{—}p, respectively, may include a plurality of scan signals SCAN (to be discussed in more detail with respect to FIG. 6) and a plurality of dimming signals DIM (to be discussed in more detail with respect to FIG. 6) which are arranged in an alternating fashion. The dimming signals DIM may control respective luminances R_LB1 through R_LB(n×m) of the first through (n×m)^{th} light-emitting blocks LB1 through LB(n×m), respectively, which will be described in detail later with reference to FIG. 6.

The data driver 500 illustrated in FIG. 1 receives the data control signal CONT1 from the first timing controller 600_1 and applies an image data voltage to each of the data lines D1 through Dj. The data control signal CONT1 includes image signals corresponding to the red, green and blue image signals R, G and B and signals used to control the operation of the data driver 500. In the present exemplary embodiment, the signals used to control the operation of the data driver 500 may include a horizontal start signal STH (to be discussed in more detail with respect to FIG. 4) for starting the data driver 500 and an output instruction signal TP (to be discussed in more detail with respect to FIG. 4) for instructing the output of the image data voltage.

The gate driver 400 receives the gate control signal CONT2 from the first timing controller 600_1 and transmits a gate signal to each of the gate lines G1 through Gk. The gate signal includes a gate-on voltage Von and a gate-off voltage Voff provided by a gate on/off voltage generator (not shown). The gate control signal CONT2 is used to control the operation of the gate driver 400 and may include a vertical start signal STV (to be discussed in more detail with respect to FIG. 4) for starting the gate driver 400, a gate clock signal CPV (to be discussed in more detail with respect to FIG. 4) for determining when to output the gate-on voltage Von, and an output enable signal OE (to be discussed in more detail with respect to FIG. 4) for determining the pulse width of the gate-on voltage Von.

Exemplary embodiments include configurations wherein the gate driver 400 or the data driver 500 may be mounted directly on the liquid crystal panel 300 in the form of a plurality of driving integrated circuits (“DICs”) or mounted on a flexible printed circuit film (not shown) to be attached to the liquid crystal panel 300 in the form of a tape carrier package. Alternative exemplary embodiments also include configurations wherein the gate driver 400 or the data driver 500 may be integrated onto the liquid crystal panel 300, together with the display signal lines (e.g., the gate lines G1 through Gk and the data lines D1 through Dj) and the switching devices Qp.

The first through (n×m)^{th} light-emitting blocks LB1 through LB(n×m) may be arranged in an n×m matrix to correspond to the display blocks DB1 through DB(n×m), respectively. Each of the first through (n×m)^{th} light-emitting blocks LB1 through LB(n×m) may include a light-emitting device (“LED”), exemplary embodiments of which include a light-emitting diode. The first through p^{th} backlight drivers 800_1 through 800_{—}p control the luminances R_LB1 through R_LB(n×m) (to be discussed in more detail with respect to FIGS. 5 and 6) of the first through (n×m)^{th} light-emitting blocks LB1 through LB(n×m) in response to the optical data signals LDAT, respectively.

Referring to FIG. 3, the first through p^{th} backlight drivers 800_1 through 800_{—}p may be connected to the first through (n×m)^{th} light-emitting blocks LB1 through LB(n×m). Specifically, the first through (n×m)^{th} light-emitting blocks LB1 through LB(n×m) may be divided into a plurality of light-emitting groups LG1 through LGq, and each of the light-emitting groups LG1 through LGq may include at least one of the first through (n×m)^{th} light-emitting blocks LB1 through LB(n×m). In one exemplary embodiment, the light-emitting groups include a column of light emitting blocks LB, and in such an exemplary embodiment, the light-emitting groups number from LG1 through LGm. The first through p^{th} backlight drivers 800_1 through 800_{—}p may be connected to the light-emitting groups LG1 through LGq. In the present exemplary embodiment, one backlight driver may be connected to one light-emitting group or a plurality of light-emitting groups. In the exemplary embodiment illustrated in FIG. 3, each of the light-emitting groups LG1 through LGq may include a corresponding column of light-emitting blocks, and one backlight driver (e.g., the first backlight driver 800_1) may be connected to two light-emitting groups (e.g., the light-emitting groups LG1 and LG2). However, the present invention is not limited thereto.

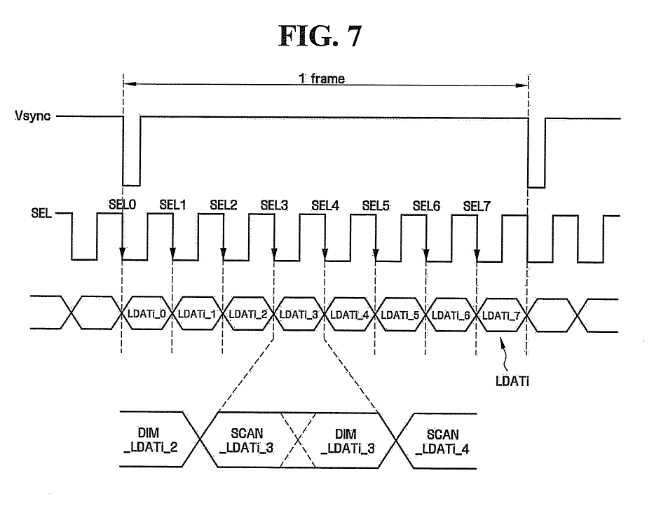

The first through p^{th} backlight drivers 800_1 through 800_{—}p may respectively receive the optical data signals LDAT from the timing controller 700, specifically, from the second timing controller 600_2 and control the luminances R_LB1 through R_LB(n×m) of the first through (n×m)^{th} light-emitting blocks LB1 through LB(n×m) included in the light-emitting groups LG1 through LGq. Each of the optical data signals LDAT input to the first through p^{th} backlight drivers 800_1 through 800_{—}p, respectively, may include the scan signals SCAN and the dimming signals DIM that are arranged in an alternating fashion, which will be described in more detail later with reference to FIGS. 6 and 7.

In one exemplary embodiment, the first through p^{th} backlight drivers 800_1 through 800_{—}p may be arranged in a direction different from a direction in which the first through (n×m)^{th} light-emitting blocks LB1 through LB(n×m) are scanned. For example, the first through p^{th} backlight drivers 800_1 through 800_{—}p may be arranged perpendicular to the direction in which the first through (n×m)^{th} light-emitting blocks LB1 through LB(n×m) are scanned.

At least two of the first through (n×m)^{th} light-emitting blocks LB1 through LB(n×m) controlled by the first through p^{th} backlight drivers 800_1 through 800_{—}p may receive different scan signals SCAN. For example, when the first through (n×m)^{th} light-emitting blocks LB1 through LB(n×m) are arranged in a matrix, at least one of the first through (n×m)^{th} light-emitting blocks LB1 through LB(n×m) controlled by the first through p^{th} backlight drivers 800_1 through 800_{—}p is disposed in each row. That is, each of the first through p^{th} backlight drivers 800_1 through 800_{—}p is involved in the scanning of at least one light-emitting block in each row. For example, as shown in the drawing, if the first through (n×m)^{th} light-emitting blocks LB1 through LB(n×m) are arranged in a matrix of rows and columns and are scanned in a column direction of the matrix, that is, scanned from top to bottom of the matrix, the first through p^{th} backlight drivers 800_1 through 800_{—}p may be arranged in a row direction of the matrix.

That is, if each of the first through p^{th} backlight drivers 800_1 through 800_{—}p is connected to a plurality of light-emitting blocks controlled by different scan signals, since each of the optical data signals LDAT includes the scan signals SCAN and the dimming signals DIM, which are alternately arranged, according to an exemplary embodiment of an LCD and a method of driving the same according to the present invention, the length of a dimming signal that must be transmitted during each of a plurality of sections, into which a frame has been divided in order to transmit different scan signals, can be reduced. Therefore, the optical data signals LDAT can be transmitted to the first through p^{th} backlight drivers 800_1 through 800_{—}p in a more stable manner, which, in turn, enhances the display quality of the LCD 10.

Referring to FIG. 4, the first timing controller 600_1 illustrated in FIG. 1 may include a control signal generator 610, an image signal processor 620, and a representative value determiner 630.

The control signal generator 610 receives external control signals and outputs the data control signal CONT1 and the gate control signals CONT2. In one exemplary embodiment, the control signal generator 610 may output the vertical start signal STV for starting the gate driver 400 of FIG. 1, the gate clock signal CPV for determining when to output the gate-on voltage Von, the output enable signal OE for determining the pulse width of the gate-on voltage Von, the horizontal start signal STH for starting the data driver 500 of FIG. 1, and the output instruction signal TP for instructing the output of an image data voltage.

The image signal processor 620 may receive the red, green and blue image signals R, G and B and output image data signals IDAT.

The representative value determiner 630 determines the representative image signals R_DB1 through R_DB(n×m) which correspond to the display blocks DB1 through DB(n×m), respectively. Specifically, the representative value determiner 630 may receive the red, green and blue image signals R, G and B and determine the representative image signals R_DB1 through R_DB(n×m). In the present exemplary embodiment, each of the representative image signals R_DB1 through R_DB(n×m) may be the mean of the red, green and blue image signals R, G and B which are provided to each of the display blocks DB1 through DB(n×m). Thus, each of the representative image signals R_DB1 through R_DB(n×m) may denote the mean luminance of each of the display blocks DB1 through DB(n×m). Alternative exemplary embodiments include configurations wherein each of the representative image signals R_DB1 through R_DB(n×m) denotes a grayscale level of each of the display blocks DB1 through DB(n×m).

Unlike the exemplary embodiment illustrated in FIG. 4, alternative exemplary embodiments include configurations wherein the representative value determiner 630 may also determine the representative image signals R_DB1 through R_DB(n×m), which correspond to the display blocks DB1 through DB(n×m), respectively, by using the image data signals IDAT.

Referring to FIG. 5, the second timing controller 600_2 illustrated in FIG. 1 includes a luminance converter 640 and an optical data signal output unit 650.

The luminance converter 640 receives the representative image signals R_DB1 through R_DB(n×m), determines the luminances R_LB1 through R_LB(n×m) of the first through (n×m)^{th} light-emitting blocks LB1 through LB(n×m) which correspond to the representative image signals R_DB1 through R_DB(n×m), respectively, and outputs the luminances R_LB1 through R_LB(n×m) of the first through (n×m)^{th} light-emitting blocks LB1 through LB(n×m) to the optical data signal output unit 650. Exemplary embodiments of the luminance converter 640 may determine the luminances R_LB1 through R_LB(n×m) of the first through (n×m)^{th} light-emitting blocks LB1 through LB(n×m) which correspond to the representative image signals R_DB1 through R_DB(n×m), respectively, by using a lookup table (not shown).

The optical data signal output unit 650 outputs the optical data signals LDAT which are to be transmitted to the first through (n×m)^{th} light-emitting blocks LB1 through LB(n×m), respectively. Each of the optical data signals LDAT may be determined by an image displayed on a corresponding one of the display blocks DB1 through DB(n×m) which receive light from the first through (n×m)^{th} light-emitting blocks LB1 through LB(n×m), respectively. In addition, the optical data signals LDAT may include the optical data signals LDAT1 through LDATp which are transmitted to the first through p^{th} backlight drivers 800_1 through 800_{—}p, respectively, during a frame in which an image is displayed on the liquid crystal panel 300 (as discussed with respect to FIG. 1). Here, the optical data signals LDAT1 through LDATp may contain the luminance information of the first through (n×m)^{th} light-emitting blocks LB1 through LB(n×m) which are connected to the first through p^{th} backlight drivers 800_1 through 800_{—}p.

Referring to FIG. 6, the optical data signal output unit 650 illustrated in FIG. 5 includes a decoder 653, a first selector 651, a second selector 652, and a serializer 654.

The decoder 653 is enabled by a vertical synchronization signal Vsync and sequentially outputs a plurality of select signals SEL during a frame before a next vertical synchronization signal Vsync is generated. The decoder 653 transmits the generated select signals SEL to each of the first selector 651 and the second selector 652. The number of select signals SEL may be determined by the number of rows in which the first through (n×m)^{th} light-emitting blocks LB1 through LB(n×m) controlled by the first through p^{th} backlight drivers 800_1 through 800_{—}p are arranged. More specifically, the number of selects signals SEL to be generated during a frame may be determined by the number of groups of the first through (n×m)^{th} light-emitting blocks LB1 through LB(n×m) to each of which the same scan signal SCAN is transmitted.

For example, if the first through (n×m)^{th} light-emitting blocks LB1 through LB(n×m) are arranged in a matrix of 8 rows and 16 columns, they may be divided into 16 light-emitting groups LG1 through LG16 which correspond to 16 columns of light-emitting blocks, respectively. In this case, each of the first through p^{th} backlight drivers 800_1 through 800_{—}p may transmit the optical data signal LDAT to two of the light-emitting groups LG1 through LGq and transmit the same scan signal SCAN to each of the eight rows. Accordingly, a frame maybe divided into 8 sections, and thus 8 select signals, e.g., the first through eighth select signals SEL0 through SEL7, maybe output sequentially. The number of select signals SEL that are output is not limited to the above example and may change depending on the number of rows and columns in the matrix of light-emitting blocks.

The first selector 651 receives the scan signals SCAN based on the luminances R_LB1 through R_LB(n×m) of the first through (n×m)^{th} light-emitting blocks LB1 through LB(n×m) received from the luminance converter 640 and outputs one of the scan signals SCAN, which corresponds to each of the select signals SEL generated by the decoder 653, to the serializer 654. Specifically, the first selector 651 sequentially outputs the scan signals SCAN which correspond to the select signals SEL sequentially received from the decoder 653.

In the exemplary embodiment illustrated in FIG. 6, the first selector 651 receives the luminances of the first through (n×m)^{th} light-emitting blocks R_LB1 through R_LB(n×m) in order to output the scan signals SCAN. However, alternative exemplary embodiments include configurations wherein the first selector 651 may output the scan signals SCAN which correspond to the select signals SEL, respectively, without receiving the luminances R_LB1 through R_LB(n×m) of the first through (n×m)^{th} light-emitting blocks LB1 through LB(n×m). In one exemplary embodiment, the first selector 651 may be a multiplexer.

The second selector 652 receives the dimming signals DIM and outputs one of the dimming signals DIM according to each of the select signals SEL generated by the decoder 653. Specifically, the second selector 652 sequentially outputs the dimming signals DIM which respectively correspond to the select signals SEL sequentially received thereby. Here, the dimming signals DIM provided by the second selector 652 may be determined by the luminances R_LB1 through R_LB(n×m) of the first through (n×m)^{th} light-emitting blocks LB1 through LB(n×m), respectively. In one exemplary embodiment, the second selector 652 may be a multiplexer.

The serializer 654 serializes the scan signals SCAN output from the first selector 651 and the dimming signals DIM output from the second selector 652 and outputs the optical data signals LDAT, each having the scan signals SCAN and the dimming signals DIM that are alternately arranged. Specifically, the serializer 654 receives the scan signals SCAN and the dimming signals DIM which respectively correspond to the select signals SEL provided sequentially and sequentially serializes the received scan and dimming signals SCAN and DIM. In one exemplary embodiment, the serializer 654 may be a shift register.

In one exemplary embodiment, the serializer 654 may place the scan signals SCAN before the dimming signals DIM. This is because the amount of signal transmitted by each of the first through p^{th} backlight drivers 800_1 through 800_{—}p can be reduced when each of the optical data signals LDAT having the scan signals SCAN that precede the dimming signals DIM is transmitted to a corresponding one of the first through p^{th} backlight drivers 800_1 through 800_{—}p, which will be described in detail later with reference to FIGS. 7 through 9.

In one exemplary embodiment, there may be a plurality of optical data signal output units, and the optical data signal output units may output the optical data signals LDAT corresponding to the first through p^{th} backlight drivers 800_1 through 800_{—}p, respectively. Specifically, in one exemplary embodiment, the second timing controller 600_2 (as discussed with respect to FIG. 1) may include a plurality of optical data signal units which correspond to the first through p^{th} backlight drivers 800_1 through 800_{—}p, respectively. Thus, the optical data signal units may provide the optical data signals LDAT to the first through p^{th} backlight drivers 800_1 through 800_{—}p, respectively, so that the optical data signals LDAT can be provided to the first through (n×m)^{th} light-emitting blocks LB1 through LB(n×m) controlled by the first through p^{th} backlight drivers 800_1 through 800_{—}p. The relationship between the optical data signal output unit 650 and the first through p^{th} backlight drivers 800_1 through 800_{—}p is not limited to the above exemplary embodiment and may change in various ways.

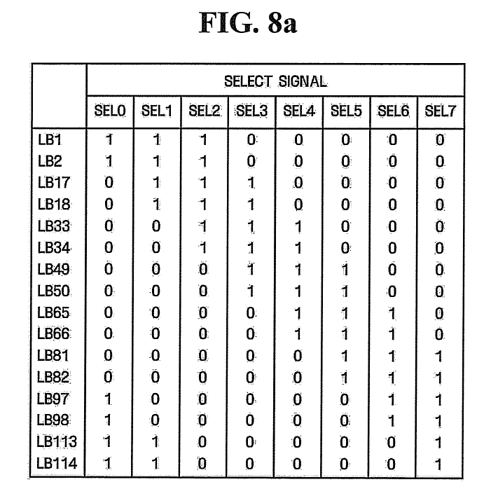

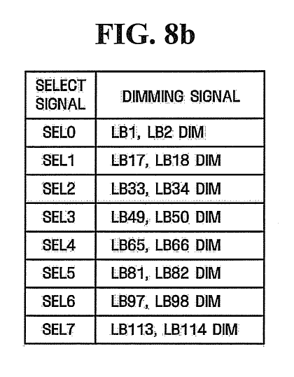

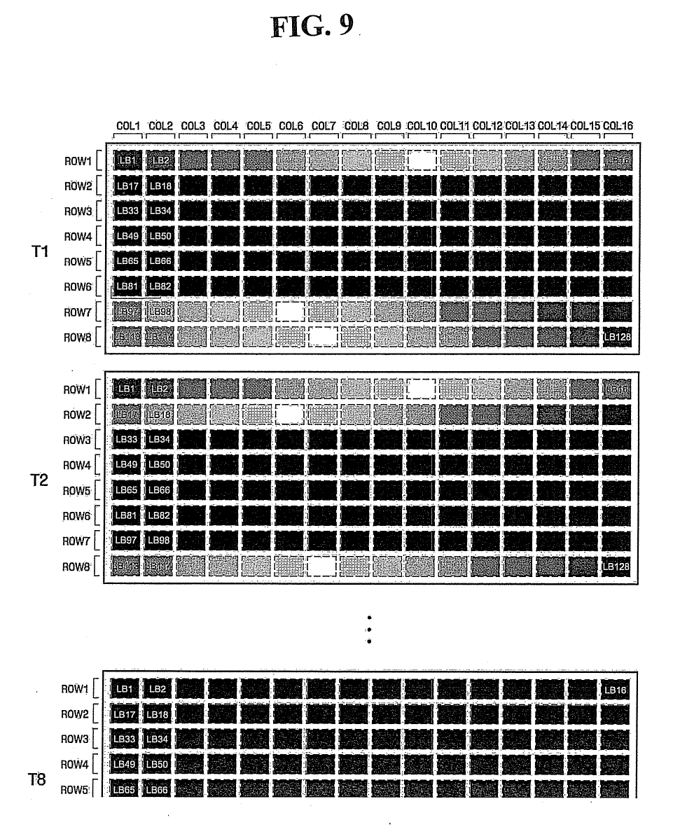

Hereinafter, an exemplary embodiment of a method of driving the exemplary embodiment of an LCD 10 of FIG. 1 according to the present invention will be described with reference to FIGS. 7 through 9. FIG. 7 is a conceptual diagram illustrating the operation of the optical data signal output unit 650 illustrated in FIG. 6. FIGS. 8A and 8B illustrate the scan signals SCAN and the dimming signals DIM which correspond to the select signals SEL, respectively. FIG. 9 is a conceptual diagram illustrating the operations of the first through (n×m)^{th} light-emitting blocks LB1 through LB(n×m) of the exemplary embodiment of an LCD 10 illustrated in FIG. 1. For ease of description, an exemplary embodiment wherein the exemplary embodiment of an LCD 10 includes first through one hundred and twenty eighth light-emitting blocks LB1 through LB128 will be described as an example, e.g., when the LDC 10 includes 8 rows and 16 columns of light emitting blocks LB.

The operation of the optical data signal output unit 650 illustrated in FIG. 6 will now be described in more detail with reference to FIG. 7. The optical data signal output unit 650 is enabled by the vertical synchronization signal Vsync which is generated once during a frame. Accordingly, the optical data signal output unit 650 sequentially generates the select signals SEL. The select signals SEL may be sequentially generated during a frame. As described above, the number of select signals SEL to be generated may be determined by the number of the first through (n×m)^{th} light-emitting blocks LB1 through LB(n×m) to each of which the same scan signal SCAN is provided, for example, the number of rows of the first through (n×m)^{th} light-emitting blocks LB1 through LB(n×m).

Referring to FIG. 7, the select signals SEL may be generated in response to the vertical synchronization signal Vsync, and each of the select signals SEL may select a corresponding one of the scan signals SCAN and a corresponding one of the dimming signals DIM. The selected scan signal SCAN and the selected dimming signal DIM may be serialized and may be included in each of a plurality of sub optical data signals which correspond to the select signals SEL, respectively.

For example, the optical data signal LDATi which is transmitted to the i^{th} backlight driver 800_{—}i may include a plurality of sub optical data signals LDATi_0 through LDATi_7 corresponding to the select signals SEL, respectively. In this case, each (e.g., the optical data signal LDATi_3) of the sub optical data signals LDATi_0 through LDATi_7 may include a scan signal (e.g., the scan signal SCAN_LDATi_3) and a dimming signal (e.g., the dimming signal DIM_LDATi_3) selected by a corresponding select signal (e.g., the third select signal SEL3). That is, each of the optical data signals LDAT may include the scan signals SCAN and the dimming signals DIM which are alternately arranged.

Referring to FIGS. 8A and 8B, the scan signal SCAN and the dimming signal DIM, which are to be provided to a backlight driver (e.g., the first backlight driver 800_1), are determined by the select signals SEL, respectively. For ease of description, the first, second, seventeenth, eighteenth, thirty-third, thirty-fourth, forty-ninth, fiftieth, sixty-fifth, sixty-sixth, eighty-first, eighty-second, ninety-seventh, ninety-eighth, one hundred and thirteenth, and one hundred and fourteenth light-emitting blocks LB1, LB2, LB17, 1B18, LB33, LB34, LB49, LB50, LB65, LB66, LB81, LB82, LB97, LB98, LB113 and LB114 controlled by the first backlight driver 800_1 will be described as an example.

In the exemplary embodiment illustrated in FIGS. 8A, 8B and 9, the light emitting blocks LB are driven according to a ⅜ on time method, wherein three of eight rows of light-emitting blocks in an 8×16 matrix of light emitting blocks LB are sequentially turned on. In this exemplary embodiment, a scan signal selected by the first select signal SEL0 may turn on the first, second, ninety-seventh, ninety-eighth, one hundred and thirteenth, and one hundred and fourteenth light-emitting blocks LB1, LB2, LB97, LB98, LB113 and LB114, e.g., LBs in the first row, seventh row and eighth row and first two columns are turned on. Next, a scan signal selected by the second select signal SEL1 may turn on the first, second, seventeenth, eighteenth, one hundred and thirteenth, and one hundred and fourteenth light-emitting blocks LB1, LB2, LB17, 1B18, LB113 and LB114, e.g., LBs in the first row, second row and eighth row and first two columns are turned on. In this way, the scan signals SCAN to be provided to the first backlight driver 800_1 may be selected by the select signals SEL, respectively.

Likewise, dimming signals selected by the first select signal SEL0 may be first and second dimming signals LB1 DIM and LB2 DIM which control the first and second light-emitting blocks LB1 and LB2, respectively. Here, each dimming signal DIM selected by each select signal SEL comprises information corresponded to the luminance of each light-emitting block during one frame. For example, first and second dimming signals LB1 DIM and LB2 DIM selected by the first select signal SEL0 comprise the information of the first and second light-emitting block LB1 and LB2 during one frame, respectively. In addition, dimming signals selected by the second select signal SEL1 may be seventeenth and eighteenth dimming signals LB17 DIM and LB18 DIM which control the luminances of the seventeenth and eighteenth light-emitting blocks LB17 and LB18, respectively, and so on. In this way, the dimming signals DIM provided to the first backlight driver 800_1 may be selected by the select signals SEL, respectively.

The scan signals SCAN and the dimming signals DIM selected by the select signals SEL, respectively, may be serialized such that they are arranged alternately as described above.

The operation of the first through (n×m)^{th} light-emitting blocks LB1 through LB(n×m) of the LCD 10 illustrated in FIG. 1 will now be described with reference to FIG. 9. FIG. 9 illustrates the luminances R_LB1 through R_LB(n×m) of the first through (n×m)^{th} light-emitting blocks LB1 through LB(n×m) over time. The scan signals SCAN and the dimming signals DIM illustrated in FIGS. 8A and 8B may have been applied to the first through (n×m)^{th} light-emitting blocks LB1 through LB(n×m). That is, the first through p^{th} backlight drivers 800_1 through 800_{—}p may respectively receive the optical data signals LDAT, each including the scan signals SCAN and the dimming signals DIM that are alternately arranged, and control the luminances of the first through (n×m)^{th} light-emitting blocks R_LB1 through R_LB(n×m) based on the received optical data signals LDAT.

In FIG. 9, those light-emitting blocks colored in black (e.g., the seventeenth through ninety-sixth light-emitting blocks LB17 through LB96 in at a time T1) from among the (n×m)^{th} light-emitting blocks LB1 through LB(n×m) are turned off during each time period. Therefore, the luminances of those not in black (e.g., the first through sixteenth LB1 through LB16 and the ninety-seventh through one hundred and twenty-eighth LB97 through LB128 at time T1) from among the first through (n×m)^{th} light-emitting blocks LB1 through LB(n×m) are controlled by the optical data signals LDAT which are transmitted to the first through p^{th} backlight drivers 800_1 through 800_{—}p, respectively.

Here, the optical data signals LDAT may be transmitted to the first through p^{th} backlight drivers 800_1 through 800_{—}p, respectively, in a serial communication method. Specifically, exemplary embodiments include configurations wherein the serial communication method may be an inter integrated circuit (“I²C”) or serial peripheral interface (“SPI”) method. Since the I²C and SPI methods are widely known serial communication methods, a detailed description thereof will be omitted.

In the present exemplary embodiment of an LCD 10 and the method of driving the same, the scanning and dimming of each light-emitting block can be simultaneously controlled by using a general, multi-channel backlight driver. In addition, in serial communication for driving each backlight driver, signals can be transmitted at a relatively low frequency, and various problems which may arise due to high-speed communication can be prevented.

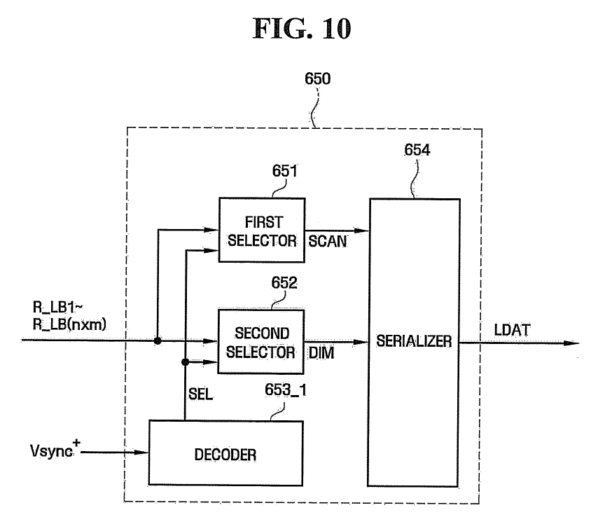

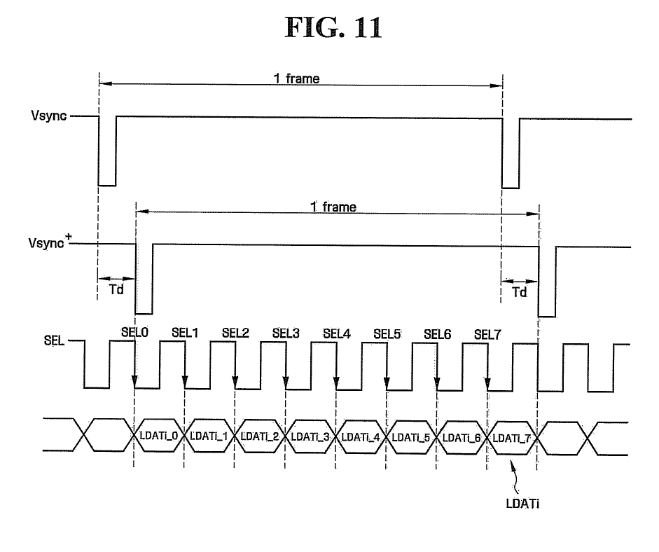

Hereafter, another exemplary embodiment of an LCD and a method of driving the same according to the present invention will be described with reference to FIGS. 10 and 11. FIG. 10 is a block diagram of another exemplary embodiment of an optical data signal output unit 650 included in another exemplary embodiment of an LCD according to the present invention. FIG. 11 is a conceptual diagram illustrating the operation of the optical data signal output unit 650 illustrated in FIG. 10.

The present exemplary embodiment of an LCD and the method of driving the same are different from those according to the previous exemplary embodiment in that a plurality of select signals SEL are generated in response to a second vertical synchronization signal Vsync+ which is obtained by delaying a first vertical synchronization signal Vsync by a predetermined period of time Td.

Referring to FIGS. 10 and 11, a decoder 653_1 is enabled by the second vertical synchronization signal Vsync+, which is the predetermined period of time Td later than the first vertical synchronization signal Vsync, and outputs the select signals SEL. In one exemplary embodiment, the optical data signal output unit 650 according to the present embodiment may further include a delay unit (not shown) which delays the first vertical synchronization signal Vsync by the predetermined period of time Td.

That is, when the second vertical synchronization signal Vsync+, which is obtained by delaying the first vertical synchronization signal Vsync by the predetermined period of time Td, is generated, the select signals SEL are generated sequentially. In addition, each of the generated signals SEL selects a corresponding scan signal SCAN and a corresponding dimming signal DIM.

Other features of the present exemplary embodiment of an LCD and the method of driving the same (such as a process of serializing the selected scan and dimming signals SCAN and DIM in order to alternately arrange the selected scan and dimming signals SCAN and DIM) are not described in the present exemplary embodiment but substantially identical to those according to the previous exemplary embodiment.

In the present exemplary embodiment of an LCD and the method of driving the same, the select signals SEL are generated in response to the second vertical synchronization signal Vsync+ which is the predetermined period of time Td later than the first vertical synchronization signal Vsync. Then, each optical data signal is transmitted to a corresponding light-emitting block when liquid crystals of a liquid crystal layer have had a sufficient period of time, e.g., Td, to respond to the voltages applied by the gate driver 400 and data driver 500. Therefore, the display quality of the LCD can be enhanced.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A liquid crystal display comprising:
a liquid crystal panel including a plurality of display blocks;
a light-emitting unit which provides light to the liquid crystal panel and includes a plurality of light-emitting blocks corresponding to the display blocks, respectively; and
a timing controller which provides an optical data signal for controlling the light-emitting blocks,
wherein the optical data signal comprises a plurality of scan signals and a plurality of dimming signals which are alternatingly arranged, and each of the dimming signals controls a luminance of a corresponding one of the light-emitting blocks.

2. The liquid crystal display of claim 1, wherein the timing controller comprises:
a first timing controller which controls an image displayed on the liquid crystal panel; and
a second timing controller which controls the luminance of each of the light-emitting blocks,
and wherein the optical data signal is obtained by selecting the scan signals and the dimming signals, which correspond respectively to a plurality of representative image signals provided by the first timing controller to the second timing controller, according to a plurality of sequentially provided select signals, and serializing the selected scan signals and the selected dimming signals.

3. The liquid crystal display of claim 2, wherein the selected scan signals precede the selected dimming signals, respectively.

4. The liquid crystal display of claim 2, wherein the select signals are sequentially provided in response to a second vertical synchronization signal which is obtained by delaying a first vertical synchronization signal that is generated once during each frame.

5. The liquid crystal display of claim 1, wherein at least two of the dimming signals are different from each other.

6. The liquid crystal display of claim 1, wherein the dimming signals are provided during a frame in which an image is displayed on the liquid crystal panel, and the scan signals control the light-emitting blocks to be turned on sequentially.

7. The liquid crystal display of claim 1, wherein the light-emitting blocks are divided into a plurality of light-emitting groups, each light-emitting group comprising one or more of the light-emitting blocks, and the light-emitting unit comprises a plurality of backlight drivers, each backlight driver driving the light-emitting blocks included in each light-emitting group.

8. The liquid crystal display of claim 7, wherein the backlight drivers are arranged in a second direction, which is different from a first direction in which the scan signals are applied to the light-emitting blocks included in each of the light-emitting groups.

9. The liquid crystal display of claim 8, wherein the first direction is perpendicular to the second direction.

10. The liquid crystal display of claim 7, wherein the optical data signal is transmitted to each of the backlight drivers using a serial communication method.

11. The liquid crystal display of claim 10, wherein the serial communication method is one of an inter integrated circuit method and a serial peripheral interface method.

12. A liquid crystal display comprising:
a liquid crystal panel including a plurality of display blocks;
a light-emitting unit which provides light to the liquid crystal panel and comprises a plurality of light-emitting blocks corresponding to the display blocks, respectively; and
a timing controller which provides an optical data signal for controlling the light-emitting blocks,
wherein the timing controller comprises:
a decoder which sequentially generates a plurality of select signals;
a first selector which receives a plurality of scan signals and outputs one of the plurality of scan signals according to each of the provided select signals;
a second selector which receives a plurality of dimming signals and outputs one of the plurality of dimming signals according to each of the provided select signals; and
a serializer which serializes scan signals and dimming signals output from the first selector and the second selector, respectively, and outputs the optical data signal having alternatingly arranged scan signals and the dimming signals.

13. The liquid crystal display of claim 12, wherein the dimming signals are provided during a frame in which an image is displayed on the liquid crystal panel, and the scan signals control the light-emitting blocks to be turned on sequentially.

14. The liquid crystal display of claim 12, wherein the serializer places the scan signal before the dimming signal in the output data signal.

15. The liquid crystal display of claim 12, wherein the timing controller further comprises a first delay unit which receives a first vertical synchronization signal that is generated once during each frame, generates a second vertical synchronization signal by delaying the first vertical synchronization signal by a predetermined period of time, and outputs the second vertical synchronization signal, and the decoder is enabled by the second vertical synchronization signal.

16. The liquid crystal display of claim 12, wherein at least two of the dimming signals are different from each other.

17. The liquid crystal display of claim 12, wherein the light-emitting unit comprises a plurality of backlight drivers which drive the light-emitting blocks included in a plurality of light-emitting groups, each group comprising one or more of the light-emitting blocks, wherein the backlight drivers are arranged in a second direction which is different from a first direction in which the scan signals are applied to the light-emitting blocks included in each of the light-emitting groups.

18. The liquid crystal display of claim 17, wherein the optical data signal is transmitted to each of the backlight drivers using a serial communication method.

19. A method of driving a liquid crystal display, the method comprising:
dividing a liquid crystal panel into a plurality of display blocks; and
providing an optical data signal for controlling a plurality of light-emitting blocks which correspond to the display blocks, respectively,
wherein the providing of the optical data signal comprises:
sequentially generating a plurality of select signals;
receiving a plurality of scan signals and outputting one of the scan signals according to each of the select signals;
receiving a plurality of dimming signals and outputting one of the dimming signals according to each of the select signals;
serializing output scan signals and output dimming signals; and
outputting the result of serialization as the optical data signal.

20. The method of claim 19, wherein the serializing of the output scan signals and the output dimming signals and the outputting of the result of serialization as the optical data signal comprises placing the output scan signals before the output dimming signals, respectively.
